(19) United States
(12) Patent Application Publication
(10) Pub. No.: US 2008/0104671 A1
(43) Pub. Date: May 1, 2008

(54) ACCESSING SERVICES

(75) Inventors: Mikko Jaakkola, Lempaala (FI); Henry Haverinen, Jyvaskyla (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/873,809

(22) Filed: Oct. 17, 2007

(30) Foreign Application Priority Data
Nov. 1, 2006 (GB) GB0621772.3

(51) Int. Cl. G06F 21/00

(52) U.S. Cl. 726/3

(57) ABSTRACT

A method, apparatus and computer program product for controlling an extent to which a user equipment is operable to use a service, at least partly based on an extent to which an operator of a first access network has certified application software associated with use of the service and/or one or more other characteristics of using the service.

### TECHNICAL FIELD

Various embodiments of the present invention relate to controlling the extent to which user equipment is operable to use services. In one embodiment, it relates to controlling the extent to which user equipment associated with a first access network is operable to use services other than via said first access network.

### BACKGROUND

User equipment can be equipped to access core network services, such as internet services, via more than one kind of wireless access network. For example, cellular wireless user equipment can be equipped to also access a core network via a wireless local access network (WLAN).

On the other hand, it is not uncommon for operators of cellular access networks to provide user equipment to their subscribers at subsidised prices with a view to recouping the loss from the revenue associated with the use of such user equipment to access voice and data services via their access network.

It has been known for a cellular network operator to configure phones provided by it to its subscribers such that the phones can only be used to access internet services via another wireless network if such access is routed via their network. In one example, the phone is configured such that WLAN usage is possible for Unlicenced Mobile Access (i.e. access through the cellular network associated with the phone) but not for any other purpose.

### SUMMARY

There has been identified the desire for network operators to provide more flexible use of the user equipment provided by them to their subscribers whilst retaining the possibility to derive income from use of the user equipment other than via their network.

Various embodiments of the present invention provide a technique that fulfils this desire.

According to one embodiment of the present invention, there is provided a method, comprising: controlling the extent to which a user equipment is operable to use a service, at least partly on the basis of the extent to which an operator of a first access network has certified the application software associated with the use of said service and/or one or more other characteristics of the method of using said service.

In one embodiment, one or more other characteristics are preferably selected from the group consisting of: the type of bearer technology associated with the use of said service; the identity of an internet access point associated with the use of said service; and the identity of one or more protocol selectors associated with the use of said service; and the method preferably comprises defining a default access policy specifying a set of properties comprising at least one of one or more internet access points, protocol selectors and bearer technology types with which services can be used; and in the absence of any certification by the first operator of the application software associated with said use of said service, controlling said use of said service according to said default access policy.

In one embodiment, the method comprises incorporating in the application software associated with the use of said service an indication of the extent to which the application software is certified by the operator of the first access network; and controlling the extent to which said user equipment is operable to use said service at least partly on the basis of said indication. It also preferably further comprises: pre-defining two or more access policies each specifying different extents to which the user equipment is operable to use services; selecting one of said two or more pre-defined access policies according to said indication in said application software; and controlling the extent to which said user equipment is operable to use said service on the basis of the selected pre-defined access policy. It also preferably further comprises selecting a pre-defined default access policy in the absence of any said indication in the application software.

In one embodiment, the method further comprises incorporating in said application software a description of an access policy specifying the extent to which the user equipment is operable to use said application software to access services, and controlling the extent to which said user equipment is operable to use said service according to the access policy described in the application software. Preferably, in the absence of any said access policy description in the application software, controlling the extent to which said user equipment is operable to use said service on the basis a pre-defined default access policy.

In one embodiment, controlling the extent to which said service may be used includes controlling the types of data packets that may be transmitted and/or controlling the types of received data packets that may be processed by said application software.

According to another embodiment of the present invention, there is provided a method, comprising: installing in a user equipment application software associated with the use of a service; and incorporating in said application software an indication of the extent to which the operator of a first access network certifies the application software for using services.

In one embodiment, said indication is incorporated into the application software before the application software is installed in the user equipment.

In one embodiment, said indication includes a description of an access policy specifying the extent to which the operator of the first access network certifies said application software for using services.

In one embodiment, said application software is installed so as to be isolated from resources of the user equipment to a degree dependent on the extent to which the application software is certified by the operator of the first access network.

According to another embodiment of the present invention, there is provided a device configured to control the extent to which a user equipment is operable to use a service, at least partly on the basis of the extent to which an operator of the first access network has certified the application software associated with the use of said service by said user equipment and/or one or more other characteristics of the method of using said service.

According to another embodiment of the present invention, there is provided a user equipment including such a device.

According to another embodiment of the present invention, there is provided a mobile handset including such a device.

According to another embodiment of the present invention, there is provided a computer program product comprising program code configured to control the extent to which a user equipment is operable to use a service, at least partly on the basis of the extent to which an operator of the first access network has certified the application software associated with the use of said service and/or one or more other characteristics of the method of using said service.

According to another embodiment of the present invention, there is provided a device for digitally signing application software relating to the use of a service by a user equipment associated with a first access network, wherein the device is configured to apply one of two or more digital signatures to application software relating to the use of a service by a user equipment associated with a first access network depending on the extent to which said application software is certified by the operator of said first access network.

In one embodiment, the digital signature includes one of two more access policy descriptions specifying the extent to which said application software is certified by the operator of said first access network.

According to another embodiment of the present invention, there is provided a computer program product comprising program code configured to apply to application software associated with the use of a service by a user equipment associated with a first access network one of two or more digital signatures depending on the extent to which said application software is certified by the operator of said first access network.

According to another embodiment of the present invention, there is provided a method, comprising: controlling the extent to which a user equipment associated with an access network operator is operable to use a service via an access network, at least partly on the basis of the extent to which said operator has certified the application software associated with the use of said service by said user equipment and/or one or more other characteristics of the method of using said service selected from the group consisting of: the type of bearer technology associated with the use of said service via said access network; the identity of an internet access point associated with the use of said service via said access network; and the identity of one or more protocol selectors associated with the use of said service via said access network.

According to another embodiment of the present invention, there is provided a device comprising means for controlling the extent to which a user equipment is operable to use a service, at least partly on the basis of the extent to which an operator of the first access network has certified the application software associated with the use of said service by said user equipment and/or one or more other characteristics of the method of using said service.

According to another embodiment of the present invention, there is provided a device comprising means for applying one of two or more digital signatures to application software relating to the use of a service by a user equipment associated with a first access network depending on the extent to which said application software is certified by the operator of said first access network.

For each of the above-described embodiments of the present invention, controlling the extent to which said user equipment is operable to use a service involves in one embodiment controlling the extent to which said user equipment is operable to use said service other than via said first access network.

According to another embodiment of the present invention, there is provided a method, comprising: controlling the extent to which a user equipment associated with an access network operator is operable to use a service via an access network, at least partly on the basis of the extent to which said operator has certified the application software associated with the use of said service by said user equipment and/or one or more other characteristics of the method of using said service selected from the group consisting of: the type of bearer technology associated with the use of said service via said access network; the identity of an internet access point associated with the use of said service via said access network; and the identity of one or more protocol selectors associated with the use of said service via said access network.

### BRIEF DESCRIPTION OF THE DRAWINGS

Embodiments of the invention are described hereunder, by way of example only, with reference to the accompanying drawings, in which:

FIG. 1 schematically illustrates a route by which a subscriber may try to use user equipment to access a service without going via the access network with which the user equipment is associated;

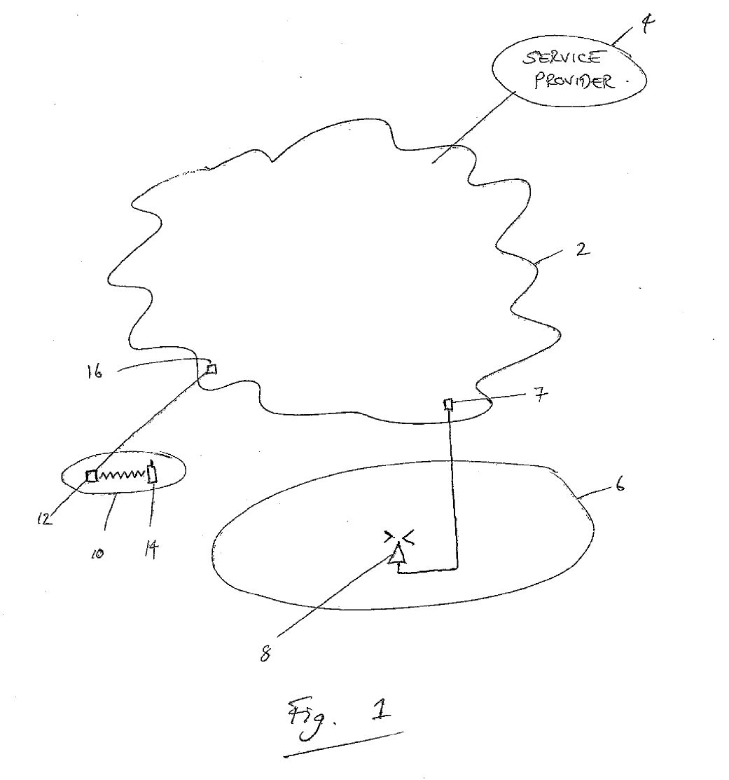

FIG. 2 illustrates a method according to one embodiment of the present invention; and

FIG. 3 schematically illustrates user equipment that is configured to implement a method according to an embodiment of the present invention.

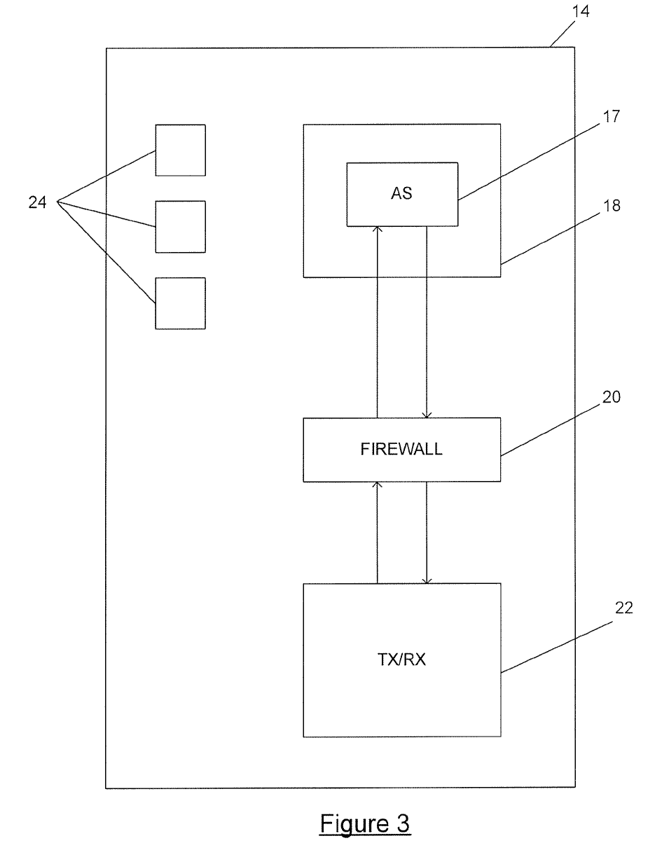

### DETAILED DESCRIPTION

According to one embodiment of the invention, a certain set of access rights to network services is chosen based on the degree to which application software provided by a service provider has been signed by the operator of the network with which the user equipment is associated. This allows the operator to limit network access or sell network access rights to 3^{rd} party developers by getting their application software certified.

According to another embodiment of the invention, access rights are not defined in terms of allowed Application Programmer's Interface (API) primitives, but access rights are defined based on the following properties:
Which bearer technologies are allowed (GPRS, WLAN, Bluetooth etc.)
Which Internet Access Points are allowed. For example, certain WLAN settings such as the operator's WLAN hotspot Internet Access Point can be allowed.
Which protocol selectors are allowed (destination IP address ranges, DNS name ranges, IP protocols such as UDP, TCP, IPsec ESP, SCCP, UDP/TCP port ranges)

Fine-grained access rights can be implemented by specifying a default access right policy, which specifies one or more bearer technologies, and/or one or more internet access points and/or one or more protocol selectors with which internet services can be used even using application software that has not been signed at all by the operator.

Described in detail below is a third embodiment based on a combination of the first and second embodiments.

The operator of a cellular access network 6 provides user equipment 14 to a subscriber to that access network, part or all of the cost of the user equipment 14 may be borne by the operator. The user equipment 14 is equipped for communication over additional bearer technologies other than that associated with the operators cellular access network. For example, the user equipment might be equipped for all of GPRS, WLAN and Bluetooth usage.

A service provider 4 provides a service via a core network 2, such as the internet. The user equipment 14 could access the internet 2 via the above-mentioned operators cellular access network 6 by wireless communication with a base station 8, and further fixed line communication via other nodes/servers (not shown) of the operators access network 6 and an internet access point 7 associated with the operators access network 6. Alternatively, the user equipment could access the internet 2 via other independently-operated access networks such as a WLAN 10, by wireless communication with a fixed station 12 of the WLAN 10 and further communication via an internet access point 16 associated with the WLAN 10. The coverage of the WLAN 10 may or may not overlap with the coverage provided by the above-mentioned operators access network 6.

When the subscriber tries to operate the user equipment 14 to access the internet 2 other than via the operators access network 6 (i.e. without going through or being routed via the operators access network 6) to use the service provided by the service provider 4, the user equipment 14 is preconfigured to control such alternative use of said internet service in the following way.

Before providing the user equipment 14 to the subscriber, the operator of the cellular access network 6 configures the user equipment 14 to control such alternative use according to one of two or more pre-defined access policies. In a simple example, two access policies can be defined: a default access policy and a full access policy. The default access policy specifies one or more bearer technologies, and/or one or more Internet Access Points, and/or one or more protocol selectors that are allowed for use in accessing an internet service regardless of whether the operator has certified the application software associated with the internet service that the subscriber wishes to use via the internet. For example, the default access policy might allow any kind of traffic over a GPRS network, but allow only basic HTTP traffic and SMTP traffic over other types of networks, such as a WLAN. The default policy thus prohibits RTP (Real Time Protocol used in voice applications) over a WLAN. In contrast, the full access policy allows any kind of traffic for any bearer technologies, Internet Access Points or protocol selectors.

When a provider of application software wishes to publish application software for using one or more services via the internet, the application software provider can ask the network operator providing user equipment to its subscribers to certify the application by digitally signing it. The operator may or may not make a charge to the application software provider for signing the application software.

When the application software 17 is installed on the user equipment 14, it is automatically placed into an isolated operating environment 18 (known as a sandbox), the degree of isolation from the user equipment's resources 24 being dependent on the extent to which the application software 17 is certified by the operator.

After starting up the application software, the packets to networking stack and transceiver 22 are processed through a kind of personal firewall software 20 that functions to filter the packets differently according to whether the default access policy or full access policy applies to said alternative use of the internet service. If the default access policy applies, any non-allowed packets (i.e. any packets which are associated with a bearer technology, internet access point or protocol selector that is/are not specified as allowed in the default access policy) are prevented from being sent to the transceiver. The same applies to the movement of packets in the other direction, i.e. from the transceiver 22 to the application software 17. The filtering out of any such non-allowed packets prevents full usage of the internet service.

According to an alternative embodiment, instead of storing a limited set of pre-defined access policies in the user equipment, an access policy description is included in digital signature applied to the application software. This would have the additional advantage of allowing the operator to create an arbitrary number of different access policies and also manage the access rights of different application software vendors differently.

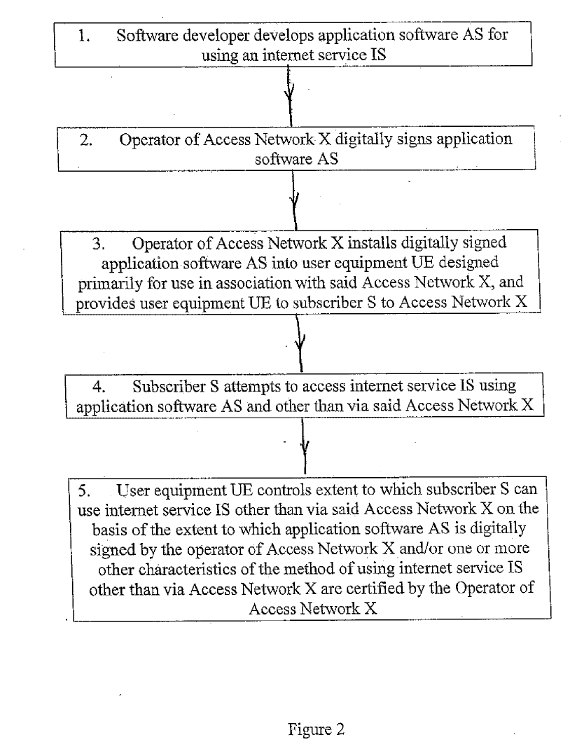

A method according to an embodiment of the present invention is illustrated in FIG. 2. Step 2 can be carried out using application signing software. Step 5 can be carried out using application signing aware application installer software that can select the right access policy (firewall policy) for the use of the application software when it is executed, and personal firewall software to enforce the selected access policy (firewall policy).

Configuration of the user equipment to select and/or enforce the appropriate access policy can be done before providing the user equipment to the subscriber. One alternative is to carry out the configuration remotely.

Appropriately adapted computer program code product may be used for configuring the user equipment. The program code product may be stored on and provided by means of a carrier medium such as a carrier disc, card or tape. A possibility is to download the program code product via a data network.

The personal firewall software mentioned above can be any personal firewall software provided that the networking stack then filters traffic based on the selected access policy (protocol selectors, bearer technology, Internet Access Point).

For user equipment already provided with existing application installer software, the application signing aware application installer function can be implemented by installing add-on application software rather than completely replacing the existing application installer with a new application installer. The access policy (filter policy) selection function could be implemented after normal application installation by separate application software that selects the access policy (filter policy). If the application software is found not to include any digital signature, the most restrictive pre-defined access policy is selected for such application software.

Merits of the above-described method according to an embodiment of the present invention include the following: application software can be sorted out into right groups before installation; policy implementation for filtering and sandboxing are 100% decoupled from each other; operator can control what services each application software can be used to access; and the operator has possibility to derive income from increasing the flexibility of use of a user equipment.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention. For example, (a) in the above-detailed description, the access networks are wireless access networks (i.e. networks involving a wireless interface with the user equipment), but the access networks could also be fixed line access networks (i.e. networks involving a fixed line interface with the user equipment); and (b) the above-detailed description relates to controlling the extent to which a user equipment is operable to use a service via an access network other than that with which the user equipment is associated, but the technique of the present invention could also be used as an alternative technique for controlling the extent to which the user equipment is operable to use a service via the access network with which the user equipment is associated.

What is claimed is:

1. A method, comprising:
controlling an extent to which a user equipment is operable to use a service, at least partly based on an extent to which an operator of a first access network has certified the application software associated with use of said service and/or one or more other characteristics of using said service.

2. A method according to claim 1, wherein said one or more other characteristics are selected from the group consisting of:
a type of bearer technology associated with use of said service;
an identity of an internet access point associated with use of said service;
and an identity of one or more protocol selectors associated with use of said service.

3. A method according to claim 2, further comprising:
defining a default access policy specifying a set of properties comprising at least one of one or more internet access points, protocol selectors and bearer technology types with which services can be used;
and in an absence of any certification by said operator of the first access network of the application software associated with said use of said service, controlling said use of said service according to said default access policy.

4. A method according to claim 1, further comprising:
incorporating in the application software associated with the use of said service an indication of the extent to which the application software is certified by the operator of the first access network;
and controlling the extent to which said user equipment is operable to use said service at least partly based on said indication.

5. A method according to claim 4, further comprising:
pre-defining two or more access policies each specifying different extents to which the user equipment is operable to use services;
selecting one of said two or more pre-defined access policies according to said indication in said application software;
and controlling the extent to which said user equipment is operable to use said service based on the selected pre-defined access policy.

6. A method according to claim 5, further comprising:
selecting a pre-defined default access policy in an absence of any said indication in the application software.

7. A method according to claim 4, further comprising:
incorporating in said application software a description of an access policy specifying the extent to which the user equipment is operable to use said application software to access services,
and controlling the extent to which said user equipment is operable to use said service according to the access policy described in the application software.

8. A method according to claim 7, further comprising:
in an absence of any said access policy description in the application software, controlling the extent to which said user equipment is operable to use said service based on a pre-defined default access policy.

9. A method according to claim 1, wherein controlling the extent to which said service may be used includes controlling types of data packets that may be transmitted and/or controlling types of received data packets that may be processed by said application software.

10. A method, comprising:
installing in a user equipment application software associated with use of a service; and
incorporating in said application software an indication of an extent to which an operator of a first access network certifies the application software for using services.

11. A method according to claim 10, wherein said indication is incorporated into the application software before the application software is installed in the user equipment.

12. A method according to claim 10, wherein said indication includes a description of an access policy specifying the extent to which the operator of the first access network certifies said application software for using services.

13. A method according to claim 10, wherein said application software is installed so as to be isolated from resources of the user equipment to a degree dependent on the extent to which the application software is certified by the operator of the first access network.

14. An apparatus, comprising: a device configured to control an extent to which a user equipment is operable to use a service, at least partly based on an extent to which an operator of a first access network has certified application software associated with use of said service by said user equipment and/or one or more other characteristics of using said service.

15. A user equipment including the apparatus according to claim 14.

16. A mobile handset including the apparatus according to claim 14.

17. An article of manufacture comprising a computer readable medium containing computer readable code, which when executed by a computer causes said computer to control an extent to which a user equipment is operable to use a service, at least partly based on an extent to which an operator of a first access network has certified application software associated with use of said service and/or one or more other characteristics of using said service.

18. An apparatus, comprising: a device configured to apply one of two or more digital signatures to application software relating to use of a service by a user equipment associated with a first access network depending on an extent to which said application software is certified by an operator of said first access network.

19. An apparatus according to claim 18, wherein the applied digital signature includes one of two more access policy descriptions specifying the extent to which said application software is certified by the operator of said first access network.

20. An article of manufacture comprising a computer readable medium containing computer readable code, which when executed by a computer, causes said computer to apply to application software associated with use of a service by a user equipment associated with a first access network one of two or more digital signatures depending on an extent to which said application software is certified by an operator of said first access network.

21. A method, comprising:
controlling an extent to which a user equipment associated with an access network operator is operable to use a service via an access network, at least partly based on an extent to which said operator has certified application software associated with use of said service by said user equipment and/or one or more other characteristics of using said service selected from the group consisting of: a type of bearer technology associated with use of said service via said access network; an identity of an internet access point associated with use of said service via said access network; and an identity of one or more protocol selectors associated with use of said service via said access network.

22. An apparatus, comprising: means for controlling an extent to which a user equipment is operable to use a service, at least partly based on an extent to which an operator of a first access network has certified application software associated with use of said service by said user equipment and means for controlling the extent to which the user equipment is operable to use said service based on one or more other characteristics of using said service.

23. A method, comprising:
providing a user equipment associated with a first access network; and
controlling an extent to which said user equipment is operable to use a service other than via said first access network, at least partly based on an extent to which an operator of the first access network has certified application software associated with use of said service other than via said first access network and/or one or more other characteristics of using said service other than via said first access network.

24. A method, comprising:
providing a user equipment associated with a first access network;
installing in said user equipment application software associated with use of a service other than via said first access network; and
incorporating in said application software an indication of an extent to which an operator of the first access network certifies the application software for using services other than via said first access network.

25. An apparatus, comprising a device configured to control an extent to which a user equipment is operable to use a service other than via a first access network with which the user equipment is associated at least partly based on an extent to which an operator of the first access network has certified application software associated with use of said service by said user equipment other than via said first access network and/or one or more other characteristics of using said service other than via said first access network.

26. An article of manufacture comprising a computer readable medium containing computer readable code, which when executed by a computer causes said computer to control an extent to which said user equipment is operable to use a service other than via a first access network with which the user equipment is associated at least partly based on an extent to which an operator of the first access network has certified application software associated with use of said service other than via said first access network and/or one or more other characteristics of using said service other than via said first access network.

27. An apparatus, comprising: a device configured to apply one of two or more digital signatures to application software relating to use other than via a first access network of a service by a user equipment associated with a first access network depending on an extent to which said application software is certified by an operator of said first access network.

28. An article of manufacture comprising a computer readable medium containing computer readable code, which when executed by a computer, causes said computer to apply to application software associated with use other than via a first access network of a service by a user equipment associated with a first access network one of two or more digital signatures depending on an extent to which said application software is certified by an operator of said first access network.

29. An apparatus, comprising means for controlling an extent to which a user equipment is operable to use a service other than via a first access network with which the user equipment is associated at least partly based on an extent to which an operator of the first access network has certified application software associated with use of said service by said user equipment other than via said first access network and means for controlling an extent to which a user equipment is operable to use a service other than via a first access network with which the user equipment is associated based on one or more other characteristics of using said service other than via said first access network.
